(19) United States
(12) Patent Application Publication
(10) Pub. No.: US 2023/0289035 A1
(43) Pub. Date: Sep. 14, 2023

(54) System and Method for Visual Data Reporting

(71) Applicant: Dennis Garlick, Studio City, CA (US)

(72) Inventor: Dennis Garlick, Studio City, CA (US)

(21) Appl. No.: 17/690,963

(22) Filed: Mar. 9, 2022

(51) Int. Cl. G06F 3/0482; G06Q 10/06

(52) U.S. Cl. CPC G06F 3/0482; G06Q 10/067

(57) ABSTRACT

A system and method for visualizing data alerts are provided. In particular, the system may be operative to identify alert conditions in complex datasets and trigger alerts based on those conditions; rate the severity of each of the one or more alerts; generate a report for each alert including instructions for resolving each alert; and, at a graphical user interface, display triggered alert groups as a listing or in grouped hierarchies depending on the number of the displayed alerts at a comprehensive alert dashboard. Alerts may be identified algorithmically or by machine learning models, and alert ratings may be visually indicated from the dashboard. Alert groupings may be made based on severity and/or geographic location of alert conditions triggering them. The system may be further operative to identify certain metadata common amongst the triggered alerts, and visually group the displayed alerts at the alert dashboard accordingly.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to data reporting, and more particularly, to system and methods for visually displaying data alerts and associated reports in a comprehensive dashboard for datasets that may be otherwise too numerous to meaningfully review.

### BACKGROUND

Advances in computing technology have enabled businesses to gather, classify, and store untold volumes of data that provide historical, current, and predictive views of business operations. This data can be collected from the market and may include, for example, data relating to customer engagement with products and advertisements, as well as data characterizing the internal operation of a business, such as financial data. This data can inform or provide insight into demand, assess needs from different market segments, and even determine the success and impact of marketing efforts. As such, this data can be used to support a wide range of business decisions, such as operations decisions including product position or pricing, or even broader strategic decisions such as identification of business priorities and goals. Thus, the regular provision of this information to decision-makers within an organization to support them in their work is crucial. In order to do so, businesses implement extract, transform, and load (ETL) procedures, known to those of ordinary skill in the art, in coordination with a data warehouse and then use one or more reporting tools.

In practice, reports generated by these tools can be used for verification of operational information and requirements, and even cross-checks.

Some systems for compiling and characterizing this data have been proposed. Such reporting tools have been implemented in some nations by Standard Business Reporting for managing business-to-government reporting obligations. For instance, some reporting software has been configured to receive or extract data from databases and, in various ways, reduce and report this often complex and voluminous data as a quantitative measure, such as by a number or statistical figure. Examples of such software available in the marketplace include Tableau®, Microsoft SSRS®, and SAP Business Objects®. These specifically comprise dashboard reporting software configured to visually and often interactively represent certain performance indicators and business data. U.S. Pat. No. 8,843,883 to Chowdhary et al. describes one such dashboard for business performance management.

Thus far, these have suffered from several drawbacks. For instance, such proposals do not successfully scale with large amounts of data handled by or characterizing large and complex organizations. In many cases, each dashboard, or region of the dashboard, will be dedicated to a specific data source and even a particular metric from the data source. As the number of data sources and metrics increases, the size and number of dashboards increases, often to unusable levels. One way of combating this issue has been to include user-selected filters to reveal a narrower set of data. Of course, a large or complex organization may feasibly generate or receive hundreds, if not many more, unique filters which would be needed to provide a comprehensive characterization of the data. Failure to precisely or accurately utilize these filters to restrict the data poses a risk that significant events, especially those applying to relatively small subsets of data, will be missed when data is aggregated across larger groups.

Although various proposals have been made to solve the problems noted above, none of those in existence combine the characteristics of the present invention. Therefore, there remains a need for a data reporting dashboard that provides access to data alerts and reports from a consolidated dashboard configured to characterize alerts of interest qualitatively, rather than quantitatively.

### SUMMARY

The present disclosure is directed to a system and method for reporting data alerts via a consolidated dashboard. The method includes processing and, at a graphical user interface, displaying large datasets as readily decipherable visualizations that enable users to visually identify information of interest subject to the alert. As such, the system is configured to qualitatively represent alerts in a comprehensive dashboard.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In general, an exemplary embodiment of the method for alert reporting comprises identifying alert conditions, identifying an alert, rating the alert, displaying the alert at a graphical user interface, and, responsive to user selection, generating an alert report.

The system and method may be configured to identify alert conditions and, ultimately, display and generate alert reports for any alerts triggered by the alert conditions applied over a dataset, however it is contemplated that certain aspects of the system and method may make them particularly useful for large datasets known to quantify, define, and/or otherwise characterize ongoing performance and activities of a business or other organization. Thus, it will be understood that the data comprising the datasets may comprise innumerable facts, figures, and records related to, for example only and not limitation, customer engagement, financial health and activity, safety conditions, weather conditions, demographics, success and failure rates for certain endeavors, and various other key performance indicators, among many others. For the avoidance of doubt, application of the system and method of visual data reporting shall not be limited by industry.

In some embodiments, the system may be configured to execute one or more algorithms for identifying alert conditions in an alert conditions identification module. For instance, the alert conditions identification module may be configured to execute an algorithm for counting certain events, such that an occurrence above or below a predetermined number of events triggers an alert. As another example, the system may be operative to execute more complex algorithms, such as those operative to perform statistical analysis. In such cases, it may be particularly useful to calculate a Z-score, or in other words, identify any deviations from the mean in standard deviations for some dataset. Of course, other statistical analyses are possible and contemplated by the invention.

The alert conditions identification module may be configured to execute additional algorithms and machine learning models in order to trigger alerts according to the alert conditions. Other alert conditions which may trigger an alert may comprise the occurrence of certain events and/or the occurrence of a certain date or time. In some embodiments, the alert conditions identification module may be further configured to exclude data from being identified under an alert condition. For instance, data may be excluded as irrelevant for a particular subset of the data. As another example, data may be excluded after an alert is triggered for a predetermined period, allowing rectification of the issue before the alert is triggered again.

Once an alert is triggered, the system may be operative to rate the alert according to its severity. In some embodiments, severity may be characterized as high, medium, low, or neutral. The severity may further be alert-specific. That is, some alerts may be exclusively rated as any of high, medium, low, or neutral. As one non-limiting example, the system may be configured to exclusively rate alerts related to safety conditions as “high.” In some embodiments, the alert conditions may inform the severity of the alert rating. For example, a certain rating may be associated with a predetermined deviation from the mean in a data set, time elapsed since the alert condition was first identified, or even the number of alert conditions identified within a particular time frame. As such, it will be understood that any basis for rating an alert by any measure may be predetermined algorithmically or as desired by a user according to their needs and interests with respect to data review.

The alert, along with its rating, may be displayed as a displayed alert for review at a graphical user interface of a computing device such as any desktop, laptop, or tablet computer, or even a smartphone. In one embodiment, elements comprising the alert may be surfaced on a comprehensive alert reporting dashboard. In one embodiment, such an embodiment comprising relatively few alerts, the displayed alerts may be presented in list form together with visual indicators of their rating, the age of the alert, and a text description of the alert. In another embodiment, such as an embodiment comprising many alerts, displayed alerts may be grouped according to various metadata common among the displayed alerts. As one non-limiting example, displayed alerts may be grouped in hierarchies according to each specific location where they originated, followed by each greater geographic region, and each country encompassing each specific location. For each hierarchical grouping, alerts may be further visually grouped according to rating.

As noted above, the system may generate visual indicators for each displayed alert rating. In embodiments comprising hierarchical groupings, alerts may be further grouped or aggregated under each hierarchical grouping according to their rating. As an example, visual indicators of displayed alert ratings may be colored balloons or other shapes. That is, in one exemplary embodiment, a red balloon may indicate a “high” severity alert, while orange indicates a “medium” severity alert, and yellow or another color may indicate a “low” severity alert. White, grey, or another color may indicate a “neutral” rating or an alert given for informational purposes only. In hierarchical groupings, all high, medium, low, or neutral rated displayed alerts may be grouped together, and the number of such displayed alerts per rating may also be visually indicated.

The system may further generate and display one or more visual indicators to relay additional information characterizing the displayed alerts. For instance, a number corresponding to the number of alerts of a certain rating type may be displayed in conjunction with the visual indicator associated with such rating type. As another example, a visual indicator may be provided to identify any previously unseen displayed alerts or alerts displayed after a particular time as new alerts.

In some embodiments, the system may be further operative to generate a listing of alerts within the hierarchy responsive to user selections of elements displayed in each hierarchy. That is, the system may enable a user to, at the display, drill down into varying levels of specificity within the hierarchy to ultimately review a particular displayed alert.

In some embodiments, the system may be operative to generate and display a summary of characteristics comprising the displayed alert, including any alert conditions that triggered the displayed alert as an alert report. Broadly, it is contemplated that any text and other contents comprising the alert report may be sufficiently detailed to provide users with all information needed to understand and act on the alert. Because of this, it is further contemplated that new alerts may be added to the dashboard or identified by the system, as desired or needed, while avoiding any need to train or retrain users as to the meaning of or appropriate response to the alert. Indeed, it will be recognized that this avoids certain human errors which may occur as a result of infrequent, vague, and/or ambiguous alerts whose responsive actions may be forgotten over time or executed improperly out of confusion or ignorance.

In some embodiments, the system may be configured to generate and display, on the alert dashboard, a graphical user interface element comprising such alert report as a tooltip, known to those of ordinary skill in the art. The alert report may comprise, for example only and not limitation, a text description of the displayed alert, any time elapsed since the system triggered the alert, any metadata associated with the alert that may be used for filtering, and any alert conditions identified by the system that caused it to trigger the alert. Of course, one skilled in the art that the form and content of the alert report may vary depending on the type of data alerted and even the needs, interests, or preferences of each user of the system. Indeed, in some embodiments, the tooltip may be customizable based on the alert. As such, it will be recognized that alerts may comprise text only, a summary of numeric data, or a combination of both, and, further, the particular form and content of the alert report will not limit the invention.

In some embodiments, the system may generate a detailed alert report as, for example, a Hypertext Markup Language- or “HTML”-page known to those of ordinary skill in the art. The detailed alert report may comprise a comprehensive listing of data and information characterizing the alert. In some embodiments, the comprehensive listing in the report may include data sources, criteria for triggering the alert, criteria for determining the rating assigned to the alert, as well as any required course of action.

Although it is contemplated that the system may reduce reliance on filters to identify and review data alert reports in data analysis, the system may still comprise user-directed means for generally filtering data alerts. This may be particularly useful in analyzing particularly large and/or complex datasets. Therefore, in some embodiments, the system may be configured to receive a user selection that filters displayed alerts according to date and/or time frame, location, line of business, data source, or other metadata associated with the alerts and/or alert conditions.

The system may also be configured to weight alerts and their underlying data in order to produce a summary measure for comparing the performance of different units comprising the business or organization utilizing embodiments of the system and method for visual data reporting. These units may comprise but are not limited to geographic locations, lines of business, or departments, for example. Indeed, in some embodiments, the system may even be configured to produce multiple summary measures using different weighting systems for each alert that are based on any aspect of business or organization performance that such alert represents or is intended or believed to represent. As just one non-limiting example, the system for visual data reporting may be configured to weigh one alert relatively heavily on a summary metric representing safety, while another alert may not feature in the summary metric representing safety at all, but may instead weigh relatively heavily on a summary metric representing customer satisfaction. Of course, innumerable other summary metrics and relative weights are possible, and thus the foregoing will not limit the invention.

It is contemplated that providing a system and method for alert reporting according to the disclosure and claims provided below may have the following advantages:
a) all reported data are accessible from a single, comprehensive dashboard;
b) adding new alerts to the dashboard as needed or desired does not require additional space on the dashboard, which allows it to scale and surface a potentially infinite number of alerts;
c) time users spend locating and interpreting alerts is reduced;
d) identification of the cause and effect of alerts is simplified;
e) standardizing text descriptions and ratings across all alerts reduces user training efforts;
f) the amount of information presented in the comprehensive dashboard is significantly reduced while maintaining access to and visibility of relevant alerts;
g) individual alert reports are sufficiently detailed to provide a user with all information they need to both understand and act on an alert, which avoids any need to continually train or retrain users how to respond to infrequent alerts or even new alerts identified by the system and added to the dashboard;
h) the elimination of user-implemented filters reduces the guesswork of making filter selections to access data of interest; and
i) the elimination of user-implemented filters further reduces the inherent bias associated with filter selection and reveals data otherwise obscured as residue from filtration.

Thus, it is an object of the invention to provide a system and method that generates a comprehensive data reporting dashboard for accessing relevant alerts in large data sets.

It is another object of the invention to render alerts as rated text descriptions that are common amongst one another to reduce ambiguity and uncertainty.

It is still another object of the invention to surface data reports on the same dashboard to increase efficiency and clarity.

It is yet another object of the invention to increase visibility of relevant alerts over the noise.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 shows a block diagram of certain system components in a system for visual data reporting in accordance with various embodiments of the invention;

FIG. 2 is a flowchart depicting an exemplary embodiment of a method for visual data reporting;

FIG. 3 shows an exemplary embodiment of a computing device comprising a graphical user interface shown in FIG. 1;

FIG. 4A-C illustrate exemplary embodiments of a user interface for the system and method for visual data reporting.

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention is typically comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denotes the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus

The terms “couple,” “coupled,” “couples,” “coupling,” and the like should be broadly understood and refer to connecting two or more elements or signals, electrically, mechanically, or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent, or semi-permanent, or only for an instant.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

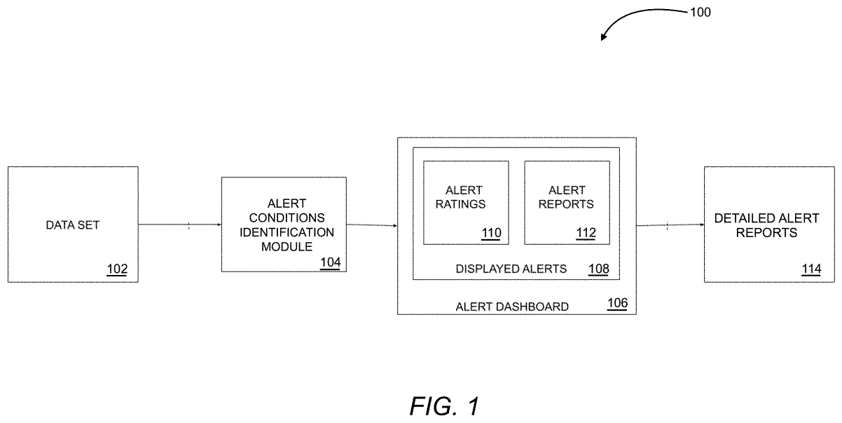

In various embodiments, and with reference to FIG. 1, a system 100 for visual data reporting comprises at least one data set 102, means for identifying alert conditions, which may be an alert conditions identification module 104, an alert dashboard 106, and for each alert triggered by the alert conditions identification module 104, a detail alert report 114. It is contemplated that the system 100 may be used in association with cloud computing, computing for mobile and wireless applications, open source computing, web services, grid or mesh computing, and any other computing means, platforms, and the like.

In an embodiment, the dataset 102 may comprise any and all information and data, or some subset of data, relating to a business or organization. This may be for instance, prefiltered and business or operation-specific sales and/or revenue information, attendance records, employee records, health and safety records, operational requirements, compliance information, and any other type of data as may be collected over the course of business or other operation. It will also be recognized that the dataset may be, to some extent, populated by a data subscriber comprising any suitable software, application programming interface, or the like, configured to retrieve and/or receive the dataset 102 or various data comprising the dataset 102 from one or more data sources. In some embodiments, then, the data may comprise unstructured datasets publicly available on the internet such as, for example only and not limitation, information contained in the news and published articles, blogs, forums, other internet resources, and the like. As such, it may be seen that the particular source of data comprising the dataset 102 will not limit the invention.

System 100 may further comprise an alert conditions identification module 104 for identifying alerts within the dataset, which itself may comprise additional software, such as web services, application programming interfaces, and the like, configured to perform a portion of the method discussed herein. Indeed, various embodiments, the system 100 for visual data reporting may comprise various software components configured to aid the alert conditions identification module 104 in executing alert-identifying algorithms and building and training machine learning models as applied to the dataset 102. In some embodiments, the alert conditions identification module 104 may even comprise, build, and maintain machine learning models for use in the system 100 for visual data reporting. For instance, the alert conditions identification 104 module may be configured to execute an algorithm for counting certain events, such that an occurrence above or below a predetermined number of events triggers an alert. As another example, the alert conditions identification module 104 may be operative to execute more complex algorithms, such as those operative to perform statistical analysis. In such cases, it may be particularly useful to calculate a Z-score, or, in other words, identify any deviations from the mean in standard deviations for some portion of the dataset 102. Of course, other algorithms, statistical analyses, and means for identifying alerts by software are possible and contemplated by the invention. This includes alerts drawn from multiple datasets or sources. For instance, it is contemplated that the alert conditions identification module 104 may be operative to execute an algorithm operative to trigger an alert when both the value of any metrics from one data source exceeds a certain threshold and any metrics from another data source exceeds the same or another threshold. As such, the alert conditions identification module 104 may be configured and operative to analyze the dataset 102, originating from one or more data sources, in order to identify and ultimately trigger alerts in any manner warranted, needed, or desired by the particular business or operation utilizing the system 100 for visual data reporting.

The system 100 for visual data reporting will further comprise an alert dashboard 106, which, in general, comprises displayed alerts 108 each comprising an alert rating 110 and alert report 112. The system 100 for visual data reporting may be further configured to generate and display detailed alert reports 114 for each alert outside of the alert dashboard 106. Such detailed alert report 114 may comprise such information as the source of data giving rise to the alert, criteria for identifying the alert and its rating, and what, if any, course of action should be followed as a result of the alert. It is contemplated that providing a detailed alert report 114 in this manner ensures that all users may be readily and adequately informed as to the meaning and source of an alert without any need of prior or otherwise specialized training.

Elements comprising the alert dashboard 106 will be discussed in more detail below.

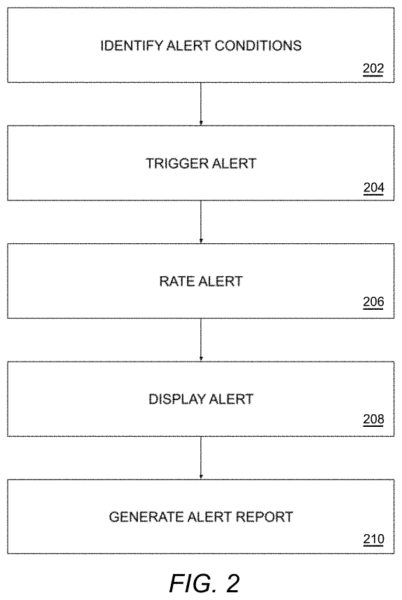

FIG. 2 is a flowchart depicting an exemplary embodiment of a method for visual data reporting. As shown in FIG. 2 the method includes the steps of: identifying alert conditions (block 202); triggering an alert (block 204); rating the triggered alert (block 206); displaying the alert (block 208); and generating an alert report (block 210). These steps in the method will be discussed in further detail with respect to the exemplary user interfaces below.

In various embodiments, the system and method for visual data reporting may include and be performed by, respectively, one or more processors and/or one or more tangible, non-transitory memories and be capable of implementing logic. The processor may be configured to implement various logical operations in response to execution of instructions, for example, instructions stored on a non-transitory, tangible, computer-readable medium, as discussed further herein. The system 100 for visual data reporting may comprise any suitable combination of hardware, software, and/or database components. For example, the system for visual data reporting may comprise one or more network environments, servers, computer-based systems, processors, databases, and/or the like.

The system for visual data reporting may also include one or more data centers, cloud storages, or the like, and may include software, such as application programming interfaces, services, or the like, configured to perform various operations discussed herein. In various embodiments, the system for visual data reporting may include one or more processors and/or one or more tangible, non-transitory memories and be capable of implementing logic. An exemplary processor may be configured to implement various logical operations in response to execution of instructions, for example, instructions stored on a non-transitory, tangible, computer-readable medium, as discussed further herein.

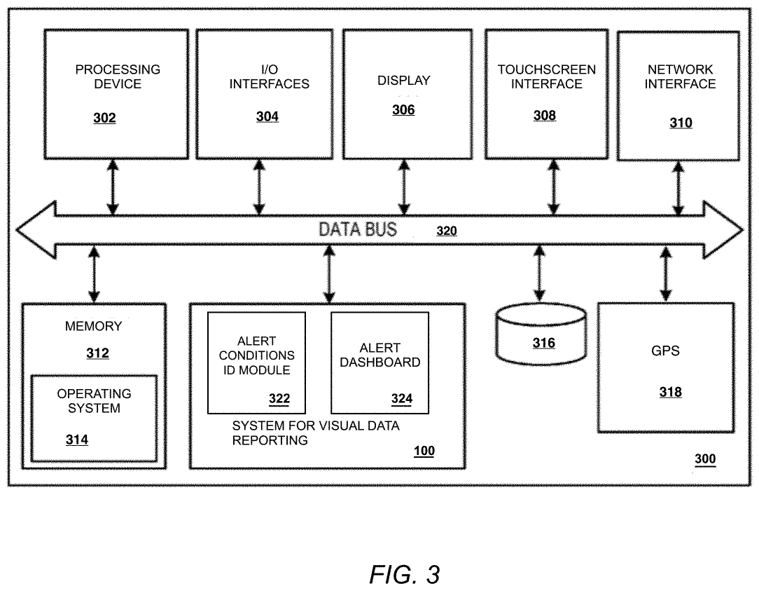

The system for visual data reporting may comprise at least one computing device in the form of a computer or processor, or a set of computers/processors, although other types of computing units or systems may be used such as, for example, a server, web server, pooled servers, or the like. In light of the foregoing, embodiments of the method for visual data reporting may be performed on a computing device 300, such as the exemplary computing device of FIG. 3. Computing device 300 may be a personal, laptop, or tablet computer or even a smartphone but may also be embodied in any one of a wide variety of wired and/or wireless computing devices. As shown in FIG. 3, computing device 300 includes a processing device (processor) 302, input/output interfaces 304, a display 306, a network interface 310, a memory 312, and operating system 314, a mass storage 316 and, with each communicating across a local data bus 320. In some embodiments, the computing device 300 may further comprise a touchscreen interface 308 and a GPS 318 communicating across the locale data bus 320, however these will not be strictly necessary to practice the invention. Additionally, computing device 300 incorporates an embodiment of the system for visual data reporting 100, which is depicted as including alert conditions identification module 322 and alert dashboard 324, though it may also include the raw dataset and detailed alert reports as discussed above. Further, the location of information 322, 324 may vary.

The processing device 302 may include any custom made or commercially available processor, a central processing unit (CPU) or an auxiliary processor among several processors associated with the computing device 300, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 312 can include any one of a combination of volatile memory elements (e.g., random-access memory (RAM, such as DRAM, and SRAM, etc.)) and nonvolatile memory elements. The memory typically comprises native operating system 314, one or more native applications, emulation systems, or emulated applications for any of a variety of operating systems and/or emulated hardware platforms, emulated operating systems, etc. For example, the applications may include application specific software which may comprise some or all the components of the computing device 300. In accordance with such embodiments, the components are stored in memory and executed by the processing device. Note that although depicted separately in FIG. 3, the system and method for coordinating visits 100 may be resident in memory such as memory 312.

In embodiments, in which the computing device comprises a touchscreen interface, touchscreen interface 308 is configured to detect contact within the display area of the display 306 and provides such functionality as on-screen buttons, menus, keyboards, etc. that allows users to navigate user interfaces by touch. It is contemplated, however, that the computing device 300 may instead, or additionally, be configured to receive user display selections and input via keyboards, touchpads, mice, and the like, which may be communicatively linked to the computing device 300.

For some embodiments, the computing device 300 will comprise GPS 318 or other means to determine the location of the computing device 300. In some embodiments of the system for visual data reporting, alert conditions may include, for instance, data origination from a location corresponding to the computing device location as determined by GPS 318.

One of ordinary skill in the art will appreciate that the memory 314 can, and typically will, comprise other components which have been omitted for purposes of brevity. Note that in the context of this disclosure, a non-transitory computer-readable medium stores one or more programs for use by or in connection with an instruction execution system, apparatus, or device. With further reference to FIG. 3, network interface device 310 comprises various components used to transmit and/or receive data over a networked environment such as depicted in FIG. 1. When such components are embodied as an application, the one or more components may be stored on a non-transitory computer-readable medium and executed by the processing device.

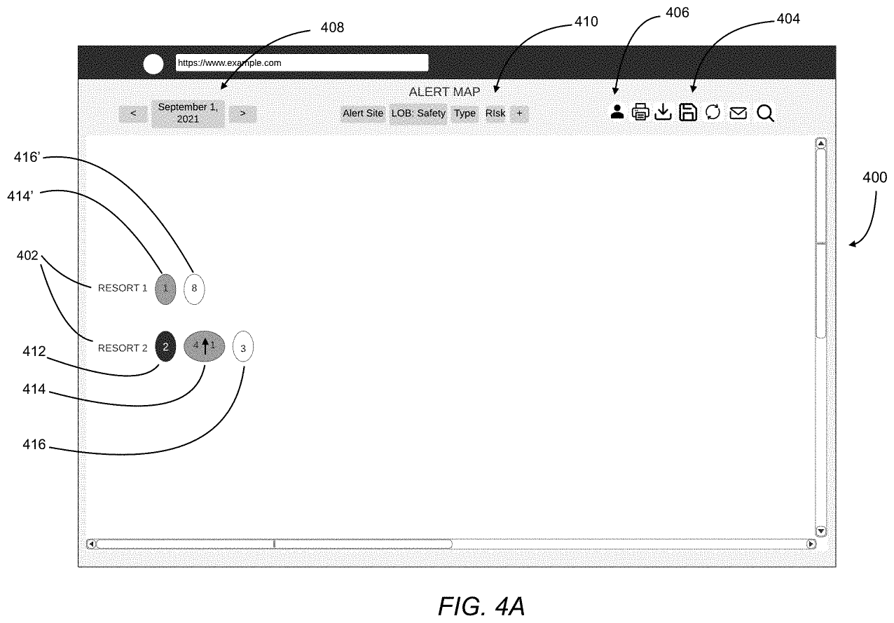

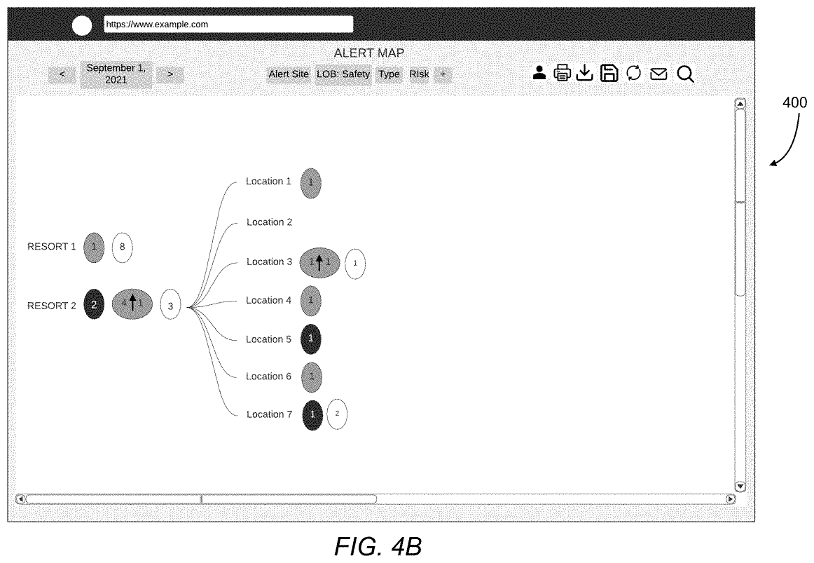

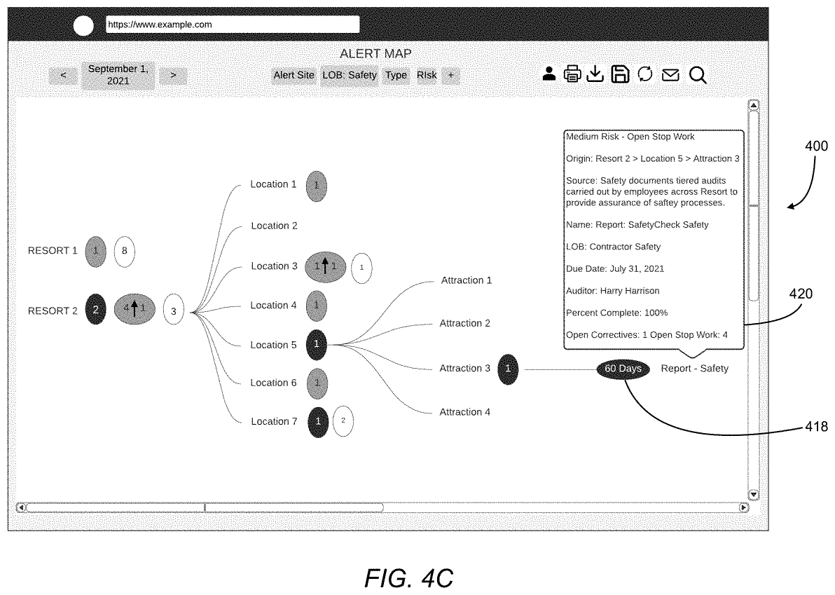

FIGS. 4A-4C illustrate exemplary interactive displays, which may be provided on the graphical user interface in accordance with one embodiment of the system and method for visual data reporting. Referring to FIG. 4A, the interface may be configured to display an alert dashboard 400 comprising one or more alerts in various groupings 402. In general, the interface may comprise any or all of conventional icons and functionality 404 such as printing, downloading, saving, refreshing, sending, and searching of, in, and amongst any part of the generated alert dashboard 400. Additionally, the interface may be user-specific and comprise a user profile 406.

While it is contemplated that the system and method for visual data reporting may reduce and even eliminate user reliance on filters to access data alerts of interest or relevance, it may be possible to filter triggered alerts for display on the alert dashboard 400 to some degree. In this case, the system is operative to receive selections to filter the date 408, alert site, lines of business, type of alert, and even risk 410 of the type of alert. The risk of an alert may be associated with its rating. Of course, other filters are possible. The foregoing are offered by way of example only and not limitation.

In this case, the exemplary business or organization generating data subject to the instant alerts comprises a plurality of resorts as the highest hierarchical level of a number of alert sites, which are labeled RESORT 1 and RESORT 2. Generic labels have been provided at each level, however, it is contemplated that the system and method of visual data reporting may be executed for datasets collected in any type of business or organization, as desired. As such, grouping names or labels may be generic, or business or organization-specific, or some combination of the same. Indeed, grouping names or labels may even be user-selected and/or assigned, determined, and/or assigned by the system for identifying alerts, or by some other means or system. The following, therefore, is presented for the sake of clarifying the invention and by way of example only and not limitation.

In addition to generally grouping alerts in this manner, it is contemplated that alerts may be further grouped according to their rating as assigned by the system. The rating may be assigned according to alert conditions or may be user-defined or selected, as discussed in more detail above. In this case, ratings are visually indicated in colored balloons generated and displayed as selectable elements on the alert dashboard 400 directly adjacent to their associated alert site.

It is notable that alerts need not be assigned to a particular location on the dashboard in order to practice the invention. Rather, any alert may appear as a symbol or text description at any relevant location on the dashboard, or not be shown at all if not currently active. The spatial layout of the dashboard, then, may be organized as desired by the business or organization utilizing embodiments of the system and method disclosed herein. That is, the location of alerts on the dashboard may be selected or assigned, as desired, based on exemplary, non-limiting criteria such as the subjective or objective importance of each alert to the business or organization, and/or regions allocated to different segments of the business or organization, such as business or organization units or sites. Such alerts that are determined to be active may be collapsed by default, but then the display may expand as needed to display them when a user clicks on the appropriate location. As such, it will be recognized that the system and method for visual data reporting are operative to scale to surface a potentially infinite number of alerts to the dashboard since the addition of new alerts will not require increased space on the dashboard to accommodate such new alerts.

Here, the exemplary balloons appear in grey scale, where the black balloon 412 visually indicates “high” severity alerts, the grey balloons 414 and 414′ visually indicates “medium” severity alerts, and the white balloons 416 and 416′ visually indicates “neutral” severity or merely informational-alerts. However, one of ordinary skill in the art will recognize that any means for visually distinguishing alert ratings is possible. The alert ratings may be visually distinguished by shape, color, shading, or the like. An additional alert grouping may be provided for “low” severity alerts. Alerts that are high, medium, or low in severity may require some attention or action to resolve or address. Merely informational alerts may not require resolution or attention. Of course, the ratings may be characterized, named, or visualized in any way desired or needed to generally prioritize those alerts requiring attention.

The alert dashboard 400 may further comprise a visual indicator of the number of alerts per each rating type, per each alert site. In this case, a number is displayed on the face of each balloon as a visual indicator of the number of alerts triggered and rated by type. In FIG. 4A, the system has triggered, and therefore displayed alert dashboard 400 on the graphical user interface, one (1) medium severity alert and eight (8) informational alerts associated with RESORT 1, and two (2) high severity alerts, four (4) medium severity alerts, and three (3) informational alerts associated with RESORT 2. It should be noted that, in this exemplary embodiment, the system has not triggered any low severity alerts for either alert site: RESORT 1 or RESORT 2. As such, no balloons or other visual indicators associated with low severity alerts are shown. In the event that the system later triggers an alert based on identified alert conditions and further rates such triggered alert as “low” severity, the system may generate and display a visual indicator associated with such rating adjacent to its associated alert site. It is contemplated that displaying graphical user interface elements rating or otherwise characterizing the triggered alerts when relevant in this manner described will streamline data reports, render data reports more easily interpreted, and effectively emphasize those alerts requiring attention.

In some embodiments, even further visual indicators may be provided to identify newly triggered or as-of-yet unseen alerts. In this exemplary embodiment, and with particular reference to grey balloon 414, an upward arrow is provided on the medium severity alert associated with alert site RESORT 2 between the numbers “4” and “1.” In some embodiments, this arrangement, and in particular inclusion of an upward arrow, may visually demonstrate that of “4” total medium severity alerts associated with RESORT 2, “1” of these is newly triggered or as-of-yet unseen by the user of the system. Of course, other means for visually indicating which, if any, triggered alerts are new or have not been seen are possible. The alert dashboard 400 may further comprise a key or legend to inform or remind users of the meaning of these and any other visual indicators for ease of use. The foregoing is offered as just one possible example of the alert dashboard 400 and visual indicators and not as a limitation on the system and method for visual data reporting.

Continuing to FIG. 4B, this exemplary embodiment of the alert dashboard 400 is configured to expand alerts, that is, to reveal subgroupings of alerts in the exemplary hierarchy, horizontally in response to user selections of alerts. However, alert expansion could occur vertically, and in some embodiments, alerts may even appear in a simple list, rather than in an expandable tree or map, without departing from the invention. In FIG. 4B, it may be seen that a first subgrouping of RESORT 2 comprises a plurality of specific locations, though generically labeled for the sake of brevity, as alert sites. Each of the alerts visually indicated for the highest order grouping of alerts under RESORT 2 have now been associated with locations at that resort. That is, upon selection of RESORT 2, the system shows that one each of the two (2) high severity alerts that were triggered for RESORT 2 in FIG. 4A, are associated with, respectively, LOCATION 5 and LOCATION 7 within the resort in FIG. 4B. It may be seen that remaining alerts from the higher-level grouping RESORT 2 have been visibly associated with their respective locations as well. As an example, it may be seen that the new or as-of-yet unseen medium severity alert referenced in connection with FIG. 4A is associated with subgrouping LOCATION 3 in FIG. 4B.

FIG. 4C illustrates an exemplary embodiment of the system and method for visual data reporting in which a user has drilled down to a terminal subgrouping ATTRACTION 3 associated with one of the exemplary RESORT 2 medium severity alerts. As above, the titles of elements in this subgrouping are offered for the sake of brevity and may appear by any appropriate title or in any number as needed. In this case, the subgrouping is characterized by a plurality of different attractions associated with each higher-level location. Of course, the particular type, character, and nature of each group and subgrouping will not limit the invention. The subgrouping ATTRACTION has been provided by way of example only, and not limitation. In an embodiment, once an alert is located within the groupings or subgroupings, the system may display within the alert dashboard 400 a summarized alert report 418. In some embodiments, this summarized alert report may comprise the time elapsed since the alert was triggered and, for instance, the type of report generated in this case, the system has categorized the alert report as a safety report. In some embodiments, the system may further comprise a tooltip 420 or other informational graphical user interface element, known to those of ordinary skill of the art, that expands on the summary of the alert. It is contemplated that the form and content of such tooltip 420 may be customizable based on the nature of the alert, line of business, and general needs and interests of the organization subject to the dataset. The exemplary tooltip 420 displayed in FIG. 4C comprises information about the alert that is potentially relevant to the user, such as the origin of the alert, the risk and effect of the alert, the source of the alert, the type of alert report, the line of business the alert is associated with, the date of the alert, the name of any individuals involved in the alert, and whether any action should be taken as correctives. While the information displayed in the exemplary tooltip 420 is conveniently labeled and summarized, it is contemplated that alert reports may simply comprise a block of text explaining pertinent aspects of the associated alert to the user. Of course, it is further contemplated that the system may generate an additional, detailed alert report outside of the alert dashboard 400, as discussed above.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, the particular form and appearance taken by the alert dashboard and graphical user interface may vary according to any number of aesthetic and functional considerations. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the system and method for visual data reporting with which that terminology is associated. In general, the terms used in the following claims should not be constructed to limit the system and method for visual data reporting to the specific embodiments disclosed in the specification unless the above description section explicitly define such terms. Accordingly, the actual scope encompasses not only the disclosed embodiments, but also all equivalent ways of practicing or implementing the disclosed system, method, and apparatus. The above description of embodiments of the system and method for visual data reporting is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the system and method for visual data reporting.

1. A method for providing a graphical user interface for visualizing data alerts for large data sets, the method comprising:
by a processor:
retrieving a dataset comprising one or more data sources;
identifying one or more alert conditions in the dataset;
triggering at least one alert corresponding to at least one of the one or more alert conditions;
rating the at least one alert; and
generating an alert report corresponding to each at least one alert; and
at a graphical user interface:
displaying, on an alert dashboard, a visual indicator associated with each at least one alert rating; and
responsive to receiving an alert selection, displaying, on the alert dashboard concurrent with the visual indicator of each other at least one alert rating, an alert report corresponding to each at least one alert;
wherein the location of each visual indicator on the alert dashboard is dynamic, and
wherein each visual indicator on the alert dashboard is configured to visually scale according to increasing or decreasing reporting requirements.

2. The method of claim 1, further comprising, by the processor, triggering a plurality of alerts corresponding to at least one of the one or more alert conditions; and grouping, at the graphical user interface, the plurality of alerts.

3. The method of claim 2, wherein the plurality of alerts are grouped according to relative severity characterized by each alert rating.

4. The method of claim 2, wherein the plurality of alerts are grouped according to any geographical location of each of the at least one alert conditions corresponding to each triggered alert.

5. The method of claim 1, wherein the alert report comprises a summary of characteristics comprising the alert, including any alert conditions corresponding to the alert, as a text description of the alert, any time elapsed since the system triggered the alert, any metadata associated with the alert, and any alert conditions identified by the processor that caused the processor to trigger the alert.

6. The method of claim 1, wherein the alert report comprises instructions for resolving the alert.

7. The method of claim 1, further comprising, at the graphical user interface, displaying, on the alert dashboard, the alert report as a tooltip.

8. The method of claim 1, wherein the visual indicator comprises a plurality of visually distinct icons configured to indicate the severity of an associated alert.

9. The method of claim 1, further comprising, by the processor, filtering the data set.

10. The method of claim 1, wherein identifying one or more alert conditions comprises executing an algorithm.

11. The method of claim 1, wherein identifying one or more alert conditions comprises executing at least one machine learning model.

12. The method of claim 1, further comprising, on the graphical user interface displaying an alert report responsive to user drilling down.

13. A system for visual data reporting comprising:
a processor; and
a tangible, non-transitory memory configured to communicate with the processor, the tangible, non-transitory memory having instructions stored thereon that, in response to execution by the processor, cause the processor to perform the method comprising:
retrieving a dataset;
executing an algorithm to identify one or more alert conditions in the dataset;
triggering one or more alerts corresponding to the one or more alert conditions;
rating the one or more alerts; and
generating an alert report corresponding to each of the one or more alerts;
displaying, at a graphical user interface, a visual indicator associated with each of the one or more alert ratings; and
responsive to receiving a selection of the one or more alerts by a user, displaying, at a graphical user interface, the alert report corresponding to each at least one alert concurrent with displaying any visual indicator associated with each of the one or more alert ratings.

14. The system of claim 13, wherein the method further comprises executing at least one machine learning model to identify alert conditions in a dataset.

15. The system of claim 13, wherein the alert report comprises a summary of characteristics comprising the alert, including any alert conditions corresponding to the alert, as a text description of the alert, any time elapsed since the system triggered the alert, any metadata associated with the alert, and any alert conditions identified by the processor that caused the processor to trigger the alert.

16. The system of claim 13, wherein the alert report comprises instructions for resolving the alert.

17. The system of claim 13, further comprising, by the processor, triggering a plurality of alerts corresponding to at least one of the one or more alert conditions; and grouping, at the graphical user interface, the plurality of alerts.

18. The method of claim 17, wherein the plurality of alerts are grouped according to relative severity characterized by each alert rating.

19. The method of claim 17, wherein the plurality of alerts are grouped according to any geographical location of each of the at least one alert conditions corresponding to each triggered alert.
